(19) United States
(12) Patent Application Publication
(10) Pub. No.: US 2006/0200583 A1
(43) Pub. Date: Sep. 7, 2006

(54) System and method for synchronisation of data between service portals and access platforms for services using such a synchronization system

(76) Inventors: Pierre-Yves Le Lann, Lannion (FR); Mari-Mai Henaff, Lannion (FR); Laurent Aubertin, Louannec (FR)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/544,289

(22) PCT Filed: Feb. 2, 2004
(86) PCT No.: PCT/FR04/00222

§ 371 Date: Aug. 3, 2005

(30) Foreign Application Priority Data
Feb. 3, 2003 (FR) 0301198

(51) Int. Cl. G06F 15/16

(52) U.S. Cl. 709/249

(57) ABSTRACT

A system for synchronizing data between service portals, each hosting at least one personal information manager (PIM) service and each of the portals being accessible by means of remote access terminals. The system includes first data synchronization means adapted to establish a correspondence between data stored in the portals. The first synchronization means includes a client-server architecture. The client and the server of the architecture respectively comprise a module hosted in one of the portals and communicating with a server implementing the personal information manager service of the portal, and a synchronization module hosted within at least the other portal and communicating with a server hosting a different personal information manager service. The modules communicate via a computer network.

The invention relates to the synchronization of data between servers implementing services accessible from portals.

More particularly, the invention relates to the synchronization of personal information between servers implementing Personal Information Manager (PIM) services accessible from Web portals.

Data synchronization consists in the establishment and maintenance of an equivalence relationship between two data collections. Following synchronization, each element of a data set corresponds to an element of the other data set, the data of these elements then being equivalent but not necessarily identical. In fact, in the case of synchronization between a mobile telephone directory and an e-mail directory, the storage capacity of the mobile telephone being relatively low, only a subset of relevant data will be transferred from the e-mail directory to the mobile telephone terminal.

A number of data synchronization solutions currently exist and are used to implement the synchronization of data loaded into respective user terminals. Such solutions serve, for example, to update and establish an equivalence relationship between data stored in a personal assistant and data stored in a microcomputer.

This type of technology has serious disadvantages insofar as, on the one hand, it requires physical proximity of the terminals to be synchronized and, on the other hand, it is applicable only to specific types of terminal for which it was developed, so that a change of hardware requires complete re-installation of the synchronization software that is used.

It has also been proposed to implement data synchronization between personal information stored in servers implementing PIM services and remote access terminals such as microcomputers, personal assistants, mobile telecommunications terminals, etc.

This technology uses synchronization servers hosted within the access portals for these services and, when a synchronization operation is requested by a user from his access terminal, enables the initiation of data synchronization between the user terminal(s) and the portal of an operator or access provider. As can be conceived, this synchronization is only suitable for implementing data synchronization between a PIM module located on a remote terminal providing access to a service portal and an online PIM module on this portal. This type of technology therefore imposes constraints if the user subscribes to a plurality of portals.

Thus, the object of the invention is to provide a method and a system for synchronization of data which are capable of implementing synchronization of data hosted within two different portals.

The invention thus proposes a system for synchronizing data between service portals each hosting at least one PIM service, each portal being accessible by means of remote access terminals. This system comprises first means for synchronization of data between the portals to establish a correspondence between the data stored in said portals.

The system further comprises second means for synchronization of data between the portals on the one hand and at least some of said terminals on the other hand.

According to another feature of the invention, the first synchronization means have a client-server architecture, the client and the server of this architecture respectively comprising, on the one hand, a module hosted in one of said portals and communicating with a server implementing the PIM service of said portal and, on the other hand, a synchronization module hosted within the other portal(s) and communicating with a server hosting a different PIM service, said modules communicating via a computer network.

The second synchronization means also have a client-server architecture, the client and the server of this architecture respectively comprising, on the one hand, a client module hosted within each of the terminals and, on the other hand, a synchronization module hosted within the portal, said client and synchronization modules communicating via a computer network.

In one embodiment, the first synchronization means further comprise means for exchanging data according to a standard data synchronization language using content description markers. This is also the case with the second synchronization means.

The personal information handled by the synchronization system comprises, for example, either data presented according to a standardized “vCard” format, or according to a standardized “vCalendar” format.

According to the invention, an access platform for services of a service portal hosting at least one PIM service is also proposed, comprising a set of at least one server providing access to said services, accessible to remote access terminals and associated with storage means in which personal information is loaded, this platform comprising a synchronization system as defined above.

This platform may further comprise means to generate a man-machine interface on the screen of the terminals, adapted to initiate the generation and transmission of synchronization commands intended for the synchronization system.

Finally, subject matter of the invention is a method of synchronizing data between service portals each hosting at least one PIM service, each portal being accessible by means of remote access terminals.

This method comprises the steps of:
generating a synchronization command using a man-machine interface supplied by a synchronization client of a client-server architecture hosted, on the one hand, in one of said portals and, on the other hand, in one other portal or the other portals, said command conveying information relating to the data to be synchronized; and
implementing the synchronization of data between the portals using a synchronization server hosted in said other portal(s) and indicated in the synchronization command.

In one embodiment, the clients and the server communicate via a computer network according to a standardized data synchronization language using content description markers.

The data to be synchronized are presented, for example, according to at least one of the standardized “vCard” and “vCalendar” formats. Thus, two-way conversion of the markers in “vCard” or “vCalendar” format is performed during the synchronization.

Other objects, features and advantages of the invention will be evident from reading the description which follows, provided merely as a non-limiting example, and with reference to the attached drawings, in which:

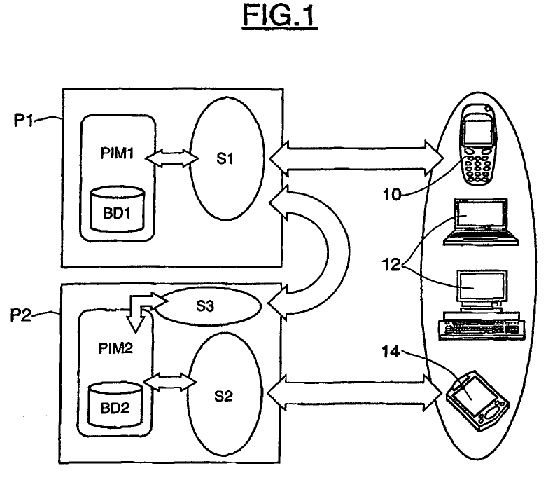

FIG. 1 schematically shows the structure of a telecommunications network enabling access to service portals;

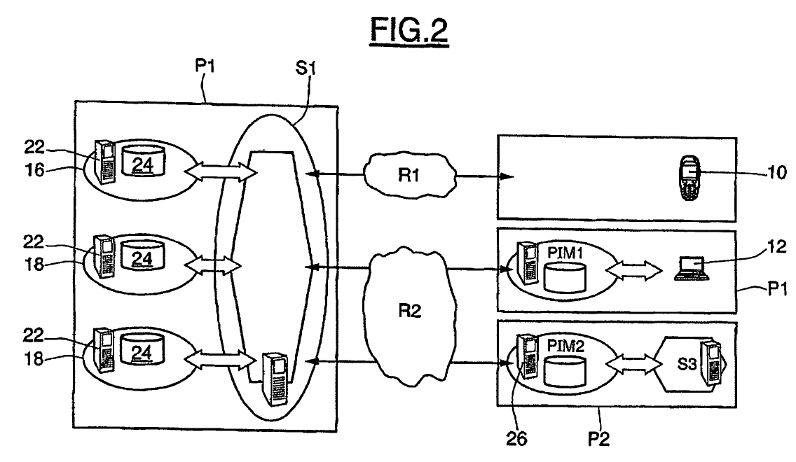

FIG. 2 shows the operation of a data synchronization server accessible from a portal and from remote access terminals;

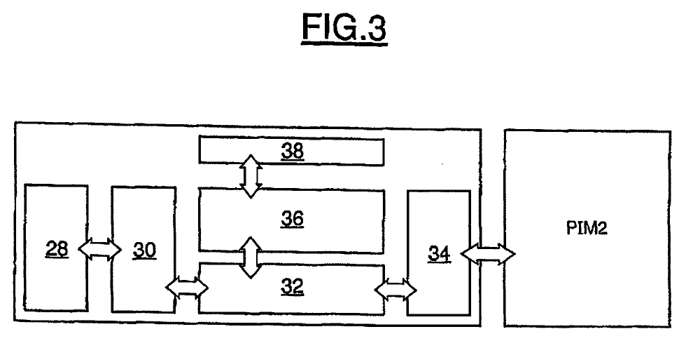

FIG. 3 shows the structure of the synchronization client used for data synchronization between two different portals; and

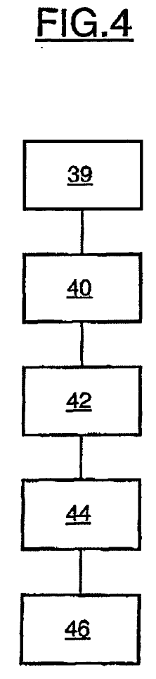

FIG. 4 is a flow chart showing the main phases of the synchronization method according to the invention.

FIG. 1 shows the general architecture of a telecommunications network enabling a user with one or more remote terminals, such as a mobile telephony terminal 10, a portable or non-portable microcomputer 12 or a personal assistant 14, to access portals P1 and P2 in order to access the Internet network.

As is known, a portal is a website whose home page offers access to a range of services of different types, and, in particular, access to one or more personal information manager services (PIM). A PIM service of this type enables the storage and management of information useful to the user, relating, on the one hand, to contacts, and, on the other hand, to events.

Thus, for example, in the embodiment shown in FIG. 1, the portal P1 enables access to a first personal information manager service PIM1 and the second portal P2 enables access to a second personal information manager service PIM2. As is known per se, each of the servers implementing these services PIM1 and PIM2 is associated with a database, BD1 and BD2 respectively, in which personal information of the user is stored in the form of “vCard” and “vCalendar” formats, concerning the contact information and event information respectively, in order to provide total interoperability of these data with the access terminals 10, 12 and 14.

These “vCard” and “vCalendar” formats are standard formats developed by the company “Versit”, enabling sharing of data relating to contact and calendar data management and event planning.

Thus, a PIM application relates either to an address book or to a calendar, or to a combined address book/calendar. In order to enable the user to carry out synchronization of the data stored in the databases BD1 and BD2, on the one hand, and the data stored in the terminals 10, 12 and 14, each of the portals P1 and P2 is provided with a synchronization server S1 and S2, communicating with the servers PIM1 and PIM2 respectively. These synchronization servers S1 and S2 form part of a client-server architecture in which the clients comprise an application installed locally on the terminals 10, 12 and 14 and controlled by the synchronization server hosted on the portals P1 and P2. Thus, the synchronization is implemented with the aid of this architecture and is essentially implemented by the servers S1 and S2 following activation by the client of the terminals 10, 12 and 14.

Moreover, in order to be able to perform synchronization of the data between the databases BD1 and BD2 accessible by the portals P1 and P2 respectively, an additional synchronization client S3 is hosted within one of the portals P1 and P2, for example the portal designated by the reference P2, in such a way as to communicate with the server PIM2 and with the synchronization server S1 hosted within the other portal, and, with the latter, to constitute a client-server architecture.

It is then possible, at the request of the user submitted from his access terminal 10, 12 or 14, to carry out either data synchronization between the databases BD1 or BD2 and the access terminals in such a way as to re-establish correspondence between the data respectively stored therein, or synchronization between the databases BD1 and BD2 to establish a correspondence relationship between the content of said databases.

As indicated above, the synchronizable data comprise PIM data compliant with the vCard standard for synchronization of address books and with the vCalendar format to synchronize diaries.

It will also be noted that the synchronization means described above, i.e. the applications of the hosted client-server model, on the one hand, within the terminals 10, 12 and 14, and within one of the portals, i.e. the portal P2, and, on the other hand, the synchronization servers S1 and S2 comprise means for exchanging intrinsically conventional data, enabling dialogue according to a data synchronization language using content description markers. The synchronization language known by the name of SyncML (“Synchronization Markup Language”), which is used to define a set of markers of an extendable XML markup language to describe the contents of the data to be synchronized, is used for this purpose, but also the format of a message used during the data exchange. The data transfer protocol used is the http protocol (hypertext transfer protocol) via the Internet network. A user may then perform synchronization between two portals, on the one hand, and between a remote access terminal and one of the servers from any geographical location using the Internet network.

In the description provided in FIG. 1, each portal P1 and P2 enables access to a service PIM1 or PIM2. Nevertheless, it is conceivable, as shown in FIG. 2, that each portal, for example the portal designated by the reference P1, in fact enables access to a range of services 16, 18 and 20, each implemented by means of servers, such as 22, and each associated with a database 24. These servers 22 and 24 communicate with the synchronization server S1, which communicates with the remote terminals 10, 12 and 14 via a wireless communications network R1, as far as the mobile telecommunications terminals are concerned, and via the Internet network R2 as far as, for example, the microcomputers 12 are concerned. The synchronization server S1 also communicates with the other portal P2 via the Internet network R2 and, in particular, with the server implementing the service PIM2 via the synchronization client S3.

It will moreover be noted that each portal P1 and P2 which, in operation, presents a home page enabling access to the set of proposed services, further generates a man-machine interface which can be manipulated by the user to generate a synchronization command and to initiate the transmission of this command to the synchronization system, such a command also being able to be generated from a button specifically implemented on the remote terminal.

It will nevertheless be noted that this interface is provided by the portal in such a way as to enable identification of the synchronization server to be used, i.e. the server S1 hosted on the portal P1 in the embodiment described with reference to FIG. 1, identification of the user using an identifier and password, selection of the remote PIM application to be synchronized and also selection of the synchronization mode, i.e. two-way or one-way, whereby a default configuration can be set up by the telecommunications operator or by the access provider to be downloaded and offered to the user.

In the case of two-way data synchronization, the databases of the two selected PIM applications are brought to a state of equivalence, i.e. modifications such as an addition, update or removal of an element of a database, carried out by the user, are passed on to the other database.

In the case of one-way data synchronization, only one of the databases is updated according to the modifications, i.e. the addition, update or removal of an element carried out by the user in a different database.

As indicated above, the synchronization system according to the invention uses a client-server architecture. The client part of this model, which is hosted on the portal P2, essentially comprises a synchronization client, i.e. an application compatible with the SyncML standard hosted within a synchronization module, and the personal information manager application PIM2. These modules comprise structurally distinct modules, a connector providing the link between the synchronization client and the server hosting the application PIM2. The synchronization client is responsible for initiating the synchronization process when a request has been submitted by the user, and is responsible for searching the database to be synchronized in order to extract the modified data and send the necessary information and data to the synchronization server S1 which is used. Similarly, it receives the information and data necessary for updating the database associated with the services server.

With reference to FIG. 3, the synchronization client S3 comprises a transport module 28 which is essentially responsible for recovering and transferring information to the selected synchronization server S1 associated with a syntactic interpreter SyncML 30, which is connected to a conversion conduit or module 32 responsible for two-way conversion of the data transmitted or received by the transport module 28, i.e. according to the XML language, into data according to the “vCard” or “vCalendar” format. The transport module 28 is responsible for transmitting and receiving messages according to the SyncML language on the transport layer used. The SyncML interpreter 30 is responsible for coding and decoding SyncML messages in accordance with the document type definitions (DTD) of the SyncML language. The conduit 32 is in turn responsible for converting a data element to be synchronized into a format compliant with the SyncML protocol, i.e. “vCard” or “vCalendar”.

This conversion module 32 is connected to a database adaptation module 34, which provides access to the databases of the server PIM2.

Similarly, the conversion module 32 communicates with an engine 36 which is responsible for setting up and maintaining a synchronization session by supervising the generation and configuration of SyncML messages sent to the synchronization server and by managing the processing of the update information received in the SyncML messages sent by the server.

This engine 36 is finally connected to an interface 38 which, as indicated above, enables the user, via a man-machine interface, to configure his preferences, the synchronization parameters, and to initiate the data synchronization process.

With reference to FIG. 4, in order to perform the data synchronization between two portals P1 and P2 and between the databases BD1 and BD2, it is appropriate in the first instance to generate a data synchronization command using a man-machine interface available on the portal P2 (step 39). As indicated above, this synchronization command comprises the identity of the synchronization server to be used, i.e. the server S1 in the example shown in FIG. 1, the identity of the user represented by an identifier-password pair, the PIM application to be synchronized, in the event that the portal enables access to a multiple service of this type, and the two-way or one-way synchronization mode requested by the user.

This synchronization command is then sent to the synchronization server S1 which is used. Following verification of the name of the server and the name of the user, the synchronization is authorized (step 40). During the following step 42, the information to be synchronized is then exchanged between the servers associated with the databases to be synchronized. During this step, the new elements are extracted and put to one side. The databases concerned are then checked in order to determine whether the new elements are already on the database to be synchronized. If not, the new elements are incorporated into this database (step 44).

During the following step 46, a correspondence table is updated in order to establish a link between the addressing of each element in the different databases concerned.

1. A system for synchronizing data between service portals each hosting at least one personal information manager (PIM) service, each of said portals being accessible by means of remote access terminals, the system comprising first data synchronization means adapted to establish a correspondence between data stored in the portals, wherein the first synchronization means includes a client-server architecture, the client and the server of said architecture respectively comprising a module hosted in one of said portals and communicating with a server implementing the personal information manager service of said portal, and a synchronization module hosted within at least the other portal and communicating with a server hosting a different personal information manager service, said modules communicating via a computer network.

2. The system as claimed in claim 1, further comprising a second means for synchronizing data between the portals and at least a portion of said terminals.

3. The system as claimed in claim 2, wherein the second synchronization means includes a client-server architecture, the client and the server of said architecture of the second synchronization means respectively comprising a client module hosted within each of the terminals and a synchronization module hosted within the portal, said client and synchronization modules communicating via a computer network.

4. The synchronization system as claimed in claim 1, wherein the first synchronization means comprises means for exchanging data according to a standardized data synchronization language using content description markers.

5. The synchronization system as claimed in claim 2, wherein the second synchronization means comprises means for exchanging data according to a standardized data synchronization language using content description markers.

6. The synchronization system as claimed in claim 1, wherein the personal information handled by the synchronization system comprises data presented according to a “vCard” format.

7. The synchronization system as claimed in claim 1, wherein the personal information handled by the synchronization system comprises data presented according to a “vCalendar” format.

8. An access platform for services of a first service portal hosting at least one personal information manager (PIM) service, the first service portal comprising a set of at least one server providing access to said services, accessible to remote access terminals and associated with storage means in which personal information is loaded, and a synchronization system between service portals including the first portal, each of said portals being accessible by means of remote access terminals and hosting at least one personal information manager service, wherein the synchronization system comprises first data synchronization means adapted to establish a correspondence between data stored in the portals, wherein the first synchronization means includes a client-server architecture, the client and the server of said architecture respectively comprising a module hosted in the first portal and communicating with a server of said set, and a synchronization module hosted within at least one other portal and communicating with a server hosting a different personal information manager service said modules communicating via a computer network.

9. The platform as claimed in claim 8, further comprising means to generate a man-machine interface on displays of the terminals, adapted to initiate generation and transmission of synchronization commands intended for the synchronization system.

10. A method of synchronizing data between service portals each hosting at least one personal information manager (PIM) service, the method comprising the steps of:
generating a synchronization command using a man-machine interface supplied by a synchronization client of a client-server architecture hosted, on the one hand, in one of said portals and, on the other hand, in at least one other portal, said command conveying information relating to data to be synchronized; and
implementing the synchronization of data between the portals using a synchronization server hosted in said other portal(s) and indicated in the synchronization command.

11. The method as claimed in claim 10, wherein the clients and the server communicate via a computer network according to a data synchronization language using content description markers (XML).

12. The method as claimed in claim 11, wherein the data to be synchronized are presented according to at least one of the “vCard” and “vCalendar” formats, and wherein two-way conversion of the markers in “vCard” and “vCalendar” format is performed in the step of implementing the synchronization.
